(19) United States
(12) Patent Application Publication
(10) Pub. No.: US 2016/0063639 A1
(43) Pub. Date: Mar. 3, 2016

(54) System and Method to Assist Crop Loss Adjusting of Variable Impacts Across Agricultural Fields Using Remotely-Sensed Data

(71) Applicant: David P. Groeneveld, Santa Fe, NM (US)

(72) Inventor: David P. Groeneveld, Santa Fe, NM (US)

(21) Appl. No.: 14/830,620

(22) Filed: Aug. 19, 2015

Related U.S. Application Data
(60) Provisional application No. 62/041,818, filed on Aug. 26, 2014.

(51) Int. Cl. G06Q 40/08; G06K 9/00; G06K 9/62; G06Q 50/02; G06T 7/00

(52) U.S. Cl. CPC G06Q 40/08; G06Q 50/02; G06T 7/0004; G06K 9/6267; G06K 9/00476; G06T 2207/10032

(57) ABSTRACT

Crop insurance is a crucial support for United States (US) farmers that will benefit from technology, especially for adjusting crop losses. Earth observation satellite (EOS) data are sufficient in resolution and repeat coverage to assess variable crop loss across fields from a variety of causes including hail, drought, and insect pests and disease and permits highly accurate estimation of impacts. Combined with spatial data that define the outline of each field, an application of the present invention can be automated to assist in crop loss adjusting, to speed the process of loss adjusting and payment, and to document the loss adjustment analysis and results. These functions enhance efficiency and lower crop loss adjusting costs for the insurance provider. Through automation and use of EOS data, this technology can be applied across many thousands of square miles at a time.

### RELATED APPLICATIONS

This application claims the benefit of U.S. Patent Application No. 62/041,818, filed Aug. 21, 2014. This provisional patent application is incorporated herein by reference in its entirety.

### BACKGROUND OF THE INVENTION

1. Field of the Invention

The present invention relates generally to the field of analysis for crop loss adjusting for assisting agents engaged by crop insurance companies.

2. Background

Companies that provide crop insurance, called Approved Insurance Providers (AIPs), are responsible for assessing losses to crops that they indemnify. Crop loss adjusters, agents, perform this assessment in a process called claims adjusting. Settlement of claims for crop loss from all causes currently requires a field visit by a crop insurance loss adjuster to assess the rates of yield loss across the affected field. This involves visits to from several to many locations in each affected field, especially where the cause of loss may produce spatially-varied impacts, that is, variation in the amount of crop loss ion different locations. Such spatial variability is the most common condition for crop losses. From point measurements, extrapolation is made by the adjuster to determine the total crop loss on the entire field. Such crop loss adjusting is often inexact because fields are frequently many hundreds of acres in size and not all of a field can be covered in the time allotted for adjustment, or due to the tall stature of the crop on many fields, even viewed.

Although an average loss from many sampled points across an affected field can be used for the overall estimate of crop loss, such estimation remains inexact because of uncertainty in apportioning where to sample. Accurate crop loss adjusting is time consuming and therefore limited due to costs associated with visiting the many locations necessary to produce accurate crop loss assessment. Clusters of crop loss often cover large regions and so, place strain on crop adjusting manpower, delay results and amplify costs through overtime labor, travel, and lodging. These are factors that greatly affect financial returns for AIPs while pressuring adjusters toward cursory assessment in order to meet tight schedules. Crop loss adjustment results are often challenged by the farmer, a situation termed “snagged claim” by AIPs. Unfortunately, by the time the loss-adjusting system registers a snagged claim, the crop on the field is no longer representative of the true loss and has likely been removed entirely by the farmer. The rush to adjust crops generally fails to produce complete documentation, leaving the AIP exposed in the event of a snagged claim.

Remote sensing data can be used to assist crop loss adjusting, enhancing accuracy and reducing the amount of field time required to obtain highly accurate results. EOS data are ideal for the present invention because they (1) are available at the 0.1 acre resolution required for crop loss adjusting, (2) are updated frequently, (3) are obtainable across areas of tens of thousands of square miles and so can address millions of acres of croplands at a time, (4) are digital and so can be manipulated through algorithms, and (5) provide for systematic extrapolation of targeted point data to assess spatial effects from many different types of impact upon crops. Within the description of the present invention, EOS also includes piloted and unpiloted aerial vehicles, since like satellites, such vehicles pass over the Earth's surface for data acquisition, only closer.

Vegetation indices, for example the normalized difference vegetation index (NDVI), use red and near infrared reflectance to disclose plant vigor within each pixel, for example a pixel of 0.1 acre represented by a 20 m×20 m area. For virtually any type of crop loss that occurs during the growing season, vegetation indices such as NDVI can correctly display the relative vegetation vigor spatially across the field. If a crop is impacted, for example by a hail storm, the degree of yield impairment of each pixel has a linear relationship with the vigor represented by vegetation indices such as NDVI.

Much of crop loss adjusting is highly complex, thereby requiring in-field analysis to determine the crop stage and the degree of the loss from crop damage. That art is highly complex and cannot be well represented using remotely-sensed data such as that obtained by EOS, alone. Crop loss adjusting can, however, be greatly enhanced through use of remotely-sensed data since these data can be used to display the relative changes across the affected field. In addition, the present system and method enhance the adjusting process while providing the documentation to avoid snagged claims and to equitably settle a snagged claim if it occurs.

The present invention enhances crop loss adjusting for impacts that cause variable yield losses across a field. There are multiple potential benefits for AIPs that use this system and method:
labor and associated costs are greatly reduced because less time is required for an accurate assessment of impacts across the field;
adjustment accuracy is enhanced;
documentation is provided for impacts across each field;
the process is used in the field on mobile devices such as electronic tablets and smartphones;
each claim is handled digitally, thus greatly increasing the efficiency for moving claims rapidly through the system;
all steps in the adjusting process can be saved for audits of the adjusted claim, when desired;
the same methods used on each field can quickly assess large regions to enable strategic mobilization of funds to lessen the impact of large claim payouts.

The present invention will lower the costs for crop loss adjusting on a wide scale, thereby lowering the cost for AIPs to perform this vital role. Lower adjusting costs will result in more profits for the crop insurance industry, enabling lower costs for crop insurance, and more rapidly provide payouts to farmers affected by loss. These benefits will enhance the economics of agriculture.

### BRIEF SUMMARY OF THE INVENTION

The present invention answers a need to enhance accuracy and efficiency for crop loss adjusting from storm events, for example from hail, or from seasonal trends, for example from drought. For event-driven crop losses, EOS data are gathered from before and after the event, processed to reflectance, used in calculating a vegetation index, and the former image subtracted from the latter image. The subtraction results in a change detection raster from which individual fields are extracted using shapefiles that define their boundaries. The change detection data for each field are ranked from least to worst crop loss and uploaded in an algorithm to a mobile GPS-equipped device that then guides the crop loss adjuster to specific locations in the field for assessment of the crop loss at each location. Once endmembers of least and greatest loss are measured, these data are entered into the mobile device that then interpolates the losses across the field. The interpolated losses and their area are then calculated by the algorithm according to the type of policy indemnifying the field. Once the least and greatest loss endmembers are established, the indemnity to be paid for the losses is calculated and transmitted for rapid and efficient handling of the claim. For trend-driven losses, the steps are the same except that trend-driven losses are calculated on the basis of a ranked vegetation index values from a single snapshot taken toward the end of the growing season. The system and method ends with the crop insurance company paying the claim, documenting the adjustment and storing the data to defend the adjustment in the event of a challenge.

### DESCRIPTION OF DRAWINGS

FIG. 1—a grayscale classification of an EOS image of a hail-damaged field in northern Texas with hail impacts ranked in ten classes from worst (10) to best (1).

FIG. 2—a mockup of a crop loss-adjusting algorithm employed on the field in FIG. 1 for use by a crop loss adjuster using a smartphone for field assessment.

FIG. 3—a flowchart describing the initial steps that begin the process of algorithm-based crop loss adjusting before the field visit.

FIG. 4—a flowchart describing the process of crop loss adjusting in the field.

FIG. 5—a flowchart describing two algorithm subroutines that enable crop loss adjustment when the worst and best locations in the subject field are not endmembers.

### LIST OF ABBREVIATIONS AND TERMS USED AND THEIR DEFINITIONS

AIP—Approved insurance provider, approved by the RMA.

AOI—Area of interest.

Change Detection—a remote sensing technique that subtracts a first image from a second image to determine locations where an index was reduced (negative number) or increased (positive number) that is appropriate for assessing changes in crop vigor.

DEM—digital elevation model that conveys geoposition (as x and y) and elevation (as z).

Endmember—a feature that represents one of the two endpoints for interpolation of crop losses following some impact.

Event—a term used here to describe crop-loss-causing immediate impacts such as hail or storm damage.

Field m—any field selected for evaluation of crop loss.

Raster—a matrix of pixels with stored values and geoposition information.

RMA—Risk Management Agency of the United States Department of Agriculture that regulates the crop insurance industry.

Shapefile—a digital vector format for storing geometric location and associated attribute information.

Smartphone—a cellular phone that performs many of the functions of a computer, typically having a touchscreen interface, Internet access, and an operating system capable of running downloaded applications.

Soil capability—the spatially-defined cumulative factors that enhance crop yield due to delivery of varying amounts of water and nutrients to the overlying crop.

Trend—a term used here to describe impacts to a crop that occur over a period of weeks to months, for example from drought.

### DETAILED DESCRIPTION OF ONE EMBODIMENT OF THE INVENTION

To assist and enhance crop loss adjusting, the present system and method classifies and ranks spatially-variable impacts across a field that may have occurred due to multiple potential causes. The present system and method is applicable to impacts caused by events, for example a hail storm that occurs on a particular day causing profound changes from one day to the next. The system and method is also applicable to conditions that are trends, not events, examples including drought and insect and disease crop damage. Trend impacts occur over the growing season or portions and must be evaluated toward the end of the season. Measurement of impacts due to events involves comparing conditions before and after the event on each field. Measurement of the changes due to a trend impact is simpler and involves fewer steps. Analysis of impact from events is described first and analysis of impact due to trends is described later.

The remote sensing technology used for the present invention uses two standard techniques, calculation of a vegetation index and Change Detection between two dates before and after a crop-impacting event. Although these methods are standard, the way that they are combined is unique.

### Evaluating Event-Caused Impacts

Applications of vegetation indices are well known in the field of remote sensing. Although NDVI is used for the present invention, any of a number of vegetation indices could be used as long as the index used following the impact is the same as before the impact. NDVI is calculated according to Equation 1. Hereafter, use of NDVI also includes the use of any other appropriate vegetation index.

$$NDVI = \frac{NIR - Red}{NIR + Red} \qquad Equation 1$$

Where: NIR is the near infrared band and Red is the red band provided by all reflected-light EOS platforms.

Change Detection within the present invention determines how the NDVI has been altered for each pixel from before to after the impacting event. In a raster calculation that manipulates data as pixels, the before is subtracted from the after. In a hail damaged field, for example, the impacts after a hail event may be variable across the field that may also have been variable before the impact due to patterns of the soil capability that ultimately supports yield. Subtraction of the before from the after results in negative values where the NDVI decreased solely due to the event. If no impact from the event occurred on some portions of the field, these would show no change, or perhaps even a positive change through crop growth during the interim between the event and the second image used for measuring the changes.

The value of Change Detection is to account for how well all portions of the field were doing before the impact to isolate the decrease in vigor due to the impact. Change Detection results for individual pixels measured from before to after, are classified and ranked across the field in the embodiment of the present invention. Classification and ranking enables choosing representative locations within the field for the crop loss adjuster to visit and record crop losses. This adjusting starts most simply with the locations of best and worst conditions of the crop. The magnitude of NDVI Change Detection is linearly related to the change in crop vigor and so, once the best and worst locations in the field are identified, visited, and measured, the adjustment for these endmembers is linearly interpolated for all Change Detection classes in between. This provides a sensitive and correct digital map of classes of loss for all pixels caused by the event.

Totaling the interpolated percent losses per pixel change across the field multiplied by the area of each pixel provides a competent spatially-variable estimate of the damage caused by the event. Simple multiplication of the percent losses by the indemnity at 100% loss provides a calculation of the indemnity to be paid to the farmer.

Change Detection for this invention embodiment results in a new raster of values of the difference from before to after. The ranking of impacts, for example in ten steps, from least to greatest change is the basis for spatially assessing the degree of crop loss. When evaluated through Change Detection, NDVI, like many vegetation indices is highly linear with regard to the loss that occurred. Therefore, by assessing endmember classes having the least impact and greatest impact, the degree of impact in each of the steps in between are also linearly related. The mathematics for Change Detection and calculation of the ranked results are presented in Equation 2.

ΔNDVIᵢ=NDVIᵢ₂−NDVIᵢ₁ Equation 2
Where Δ is the change between the time steps 1 and 2 of the ith pixel. Time step 2 is after the impact and the values of ΔNDVI for the damaged crop are therefore negative.

The values resulting from Equation 2 are divided [up] into a set number of bins of equal width, also called percentiles. The bin width of ΔNDVI from the least to highest values is established according to Equation 3.

$$Bin Width = \frac{( Δ {NDVI}_{i max} - Δ {NDVI}_{i min} )}{N} \qquad Equation 3$$

Where N is the desired number of bins and max and min define the range of ΔNDVIᵢ values. Bin width is a positive number.

A person of ordinary skill will appreciate that the number of bins to express the steps within the distribution can vary depending upon the precision required. Ten bins are chosen here for convenience in discussion of the present embodiment of the invention. The range of each bin is defined according to the bin width of Equation 3 and mathematics in Equation 4. The bin content is not biased by the selection of the range.

$$Bin n least value \text{:} = Δ {NDVI}_{i max} - 1 \text{-} n ( Bin Width ) \\ Bin n upper value \text{:} = Δ {NDVI}_{i max} - n ( Bin Width ) \qquad Equation 4$$

Where n designates the bin number, for example bin 1 of bins 1 through 10, where bin 1 represents the best condition remaining in the field, or the highest ΔNDVIᵢ bin for that field. Note that impacted portions of the field have negative values from change detection and so a lower ΔNDVIᵢ value receives a higher bin number representing higher crop loss. The deltas (Δ) derived through change detection are omitted for trend-caused impacts as described later.

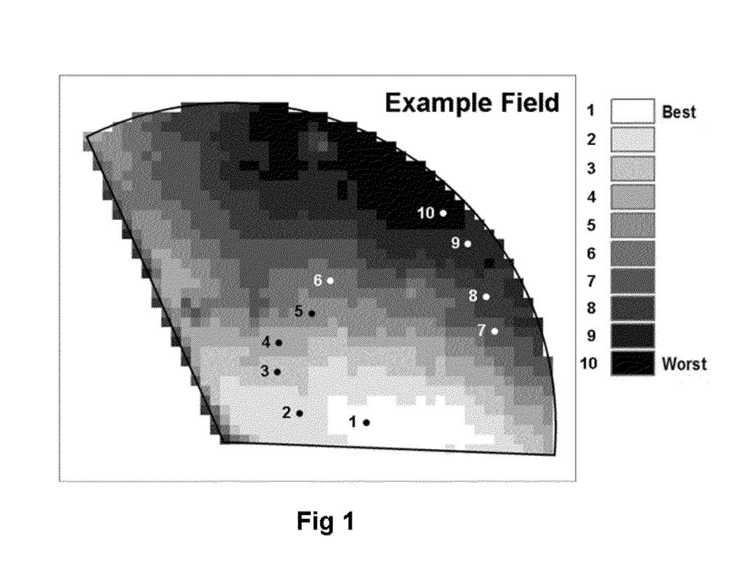

The workflow represented by Equations 1 through 4 results in classified and ranked pixels across the impacted field that are the basis for the adjusting estimate of crop loss. FIG. 1 portrays ten such ranked classes across a field impacted by a hail event.

Change Detection is a simple and powerful method to document the spatial changes that have occurred across areas affected by an event. NDVI and other vegetation indices are profoundly affected by absorption and attenuation that may be highly variable depending upon the aerosol content of the atmosphere overlying a target field. Fortunately, the use of Change Detection, classification, and ranking nullifies this effect. Change Detection forces the comparison of all parts of a field to be relational and balanced. The classification, from best to worst, are addressed numerically during the crop adjusting fieldwork by assessing the endmembers represented by the best and worst locations. The degree of change of crop canopy vigor is relational and highly correlated to actual crop losses as has been confirmed through field verification. The degree of change measured between the endmembers, max and min, sets the range of possible ΔNDVIᵢ throughout the field and also the bin width values per Equation 3.

### Evaluating Trend-Caused Impacts

The difference between trend-caused impacts and event-caused impacts is that event-caused impacts are evaluated using Change Detection while trend-caused impacts are not. All other steps remain the same. For event-caused impacts, Change Detection is used to remove the spatially-defined effects due to soil capability because they are not germane to the event that caused the impact. As used here, soil capability is the spatially-defined cumulative factors that enhance crop yield due to potential delivery of varying amounts of water and nutrients to the overlying crop. Soil capability is a general term that includes effects upon crop growth imparted through combinations of topographic slope that may generate runoff, swales that may concentrate any precipitation that is received, and soil water holding characteristics that govern how much plant available water will be stored once received. These conditions tend to be variable across cultivated fields.

Drought equally affects the precipitation water received on all portions of a field, however, drought causes variable impact spatially because the soil properties and topography across cultivated fields affect the concentration and storage of water for plant use and the rates of evapotranspiration (ET) that diminish that storage. The resulting spatially-variable impacts on a field caused by drought warrants the use of the present invention for crop loss adjusting but without the inclusion of Change Detection. Change Detection eliminates the governing effects of soil capability that were operating before imposition of trend conditions.

Although insect pests and crop diseases are not direct analogs of drought, they are more trend-driven than event-driven because they take time to develop. The degree of soil capability is directly related to a crop's resistance to biological pests. A person of ordinary skill will recognize that insect pests and diseases of crops can be assessed using the present invention but with potential minor alteration of the workflow to develop the output data for field verification.

A person of ordinary skill will also recognize that the effects from of trend-caused impacts upon yield may also be best assessed near the end of the growing season when the reduction of yield across the field due to insect pests or crop diseases is best compared to the remaining unimpacted portions of the field for calculation of the indemnification. Such considerations can readily be built into the embodiment of the present invention for adjusting any trend-caused impact.

### Methods for Adjusting Measurements in the Field

For both event-driven and trend-driven impacts, the method of the embodiment for the present invention for use in the field is the same except for Change Detection applied to event-driven losses. Ranked classes of crop change for the event-driven impacts and the relative yield for the trend-driven impacts are both well suited to use the same method that is developed here but with the different considerations for each.

The crop loss determination by the adjuster at each location visited for adjusting is complex and follows protocols and charts that are different for each crop type. For example, an early season hail impact to a soybean crop that suffers the same density of hail strikes as an adjacent corn crop will recover with little or no yield loss while the corn crop may be a complete loss. Crop timing is also important because the same storm later in the season may cause complete losses for both corn and soybeans. For this reason, the present invention does not try to encode all of the contingencies for crop damage for automated adjusting. The adjuster still determines the level of crop loss, and the remote sensing input in this present invention serves as guidance for the adjuster to perform the adjusting more quickly, efficiently and accurately. Otherwise, an adjuster commonly visits and evaluates numerous locations and takes the average loss with no guidance about where to visit in the field and with no guarantee of its accuracy.

Identification of values of ΔNDVIᵢ (event-driven) or NDVIᵢ (trend-driven) endmembers and all other calculations for the present invention are made with the method of the embodiment of the present invention. In this process, endmembers may be mapped that are not representative of the actual endmembers needed for crop loss adjusting. An example is a field that has been hit extremely hard by a hail storm leaving portions of the field completely stripped of leaves, with only bare stalks exposed. Though these highly impacted locations are the actual worst locations in the field, portions of the field that have lower ΔNDVIᵢ may still represent 100% crop loss.

The method of the embodiment of the present invention accommodates the condition where multiple classes have 100% loss by directing the adjuster to find the lowest class number that still represents 100% loss for interpolating losses across the field. This is accomplished by confirming that the next lower class number has a ΔNDVIᵢ with some loss amount less than 100%.

Thus, if the maximal loss is 100%, the adjuster iteratively goes to the next lower classes looking for less than 100% loss. In the same manner, the least class number, class 1, should record at least some loss or the adjuster must go to the next higher class number to find an impact representing the low-loss endmember for purposes of interpolation. If the class is not such an endmember, then the next higher class must be visited. Evaluation of trend-driven impacts must also follow this convention.

The fewest locations for an adjuster to visit using the present invention in any field is two, the best and worst locations in the field. More than two locations are necessary if the best and worst endmembers are not more than 0% loss or less than 100% loss, respectively. Most commonly, the number of locations requiring a visit will be two for application of the present invention. This is a significant improvement over the present state of crop loss adjusting that requires evaluating fractional crop losses at dozens of locations on the field without guidance and then averaging to develop a representative total-field loss estimate.

The area of each pixel, for example 0.1 acre, multiplied by the measured or interpolated percent loss and the dollar value for 100% loss determines the lost value for that pixel. Summation of the dollar loss value across the field results in an adjusted total of the loss on the subject field as shown in Equation 5.

$Lossₘ=Σₘ(Lᵢ*A*$_{100%}) Equation 5
Where: Σ is a summation for the entire subject Field m, L is the fractional loss on the ith pixel of Field m, A is the area of each pixel in acres and $_{100%} is the full indemnity for 100% loss per acre.

Equation 5 represents a simplified method for calculation of the indemnity for field m. Some insurance products may require different methods for calculation of the indemnity, in which case, Equation 5 will be altered. However, the basic formula of percent loss multiplied by area other factors and summed over the field is applicable.

### Field Application of the Present Invention

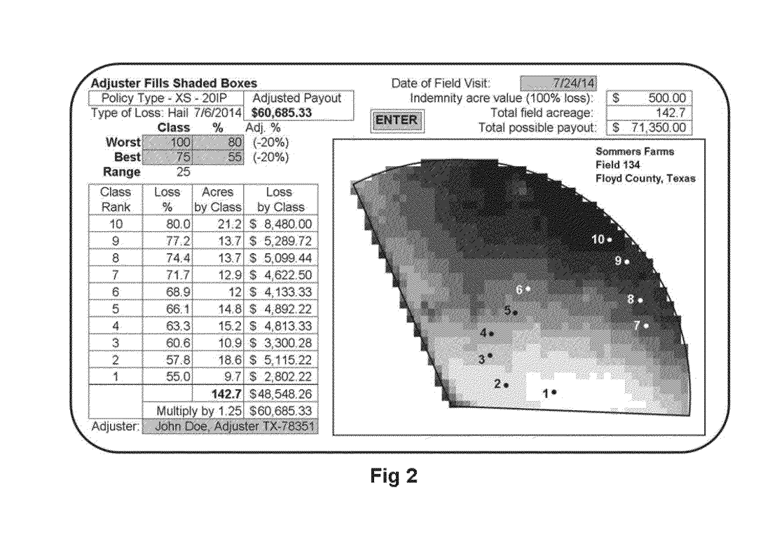

FIG. 2 presents an example of a smartphone application to be used for adjusting crop losses. The adjuster simply enters the date of the field verification and the results from visiting two or more locations in the field. All other data was transmitted by the AIP with notification of the claim. The use of a smartphone here is also taken to mean any portable device equipped with global positioning system (GPS), capable of hosting the algorithm to perform calculations, having memory storage and linkage with the Internet through wireless connectivity. An example of another commonly-used electronic device that fits this description is a portable electronic tablet.

The crop adjusting process begins with notification of the claim, the type of loss, the policy type and date of the loss event. All of this information is necessary for the calculation of the payout and is sent by the AIP at the time of notification of the claim. The date of the event must be known in order to acquire an EOS image from before the event. Ideally for accuracy, the before image should be within a week or two before the event. The after image must be timed to allow maturation of the crop impact to achieve the greatest visibility of the zones damaged by the event—10 days to 20 days following the event is ideal. The term “ideal” is used here to convey that if the actual dates of the images cannot fit within the suggested time window the analysis may still yield appropriate and useable results.

FIG. 2 is a mockup of a smartphone application and the final product may look quite different from what the algorithm display page on this figure portrays. For example, this illustration shows the interpolated values of the indemnity between the highest loss class, rank 10 and the lowest loss class, rank 1. Such interpolation may best be held in the background because these data are calculated automatically by the algorithm and are not of direct interest to the adjuster. These class-based calculations are presented simply to show the interpolation through the various steps. In this example, class 9 was visited and found to be less than 100%. The data required to be entered by the adjuster in this example are limited to just five fields as indicated on FIG. 2—highest and lowest class endmembers, the percent loss for these classes and the date. All other calculations can be relegated to the algorithm operating in the background.

FIG. 2 represents only the page where the adjuster enters the appropriate data needed for the adjustment of the subject field with one page for each field. Additional pages to assist the adjuster can be part of the algorithm, for example a map of the region that locates the smartphone held by the adjuster and provides a route to navigate to the affected field. Another page can provide a map of the affected fields since multiple fields are often affected for each farm. This page can also contain contact information for the farmer since it is customary to make contact before entering a field for loss adjustment. Another important page can present a detailed map of the field so that the adjuster can navigate to find the point indicated by the algorithm that is shown on FIGS. 1 and 2. Other pages can contain the graphs and tables necessary for calculation of the loss on each location visited. None of these pages is listed in the flowcharts to follow because their inclusion and use are obvious to a person of ordinary skill designing a service to assist crop loss adjusting.

In addition to entering the data necessary for the loss adjusting, the smartphone page shown on FIG. 2 also contains a button, “enter”, to finalize the loss adjustment. Pressing the enter button can engage the smartphone to upload the adjustment if connectivity with the internet is sufficiently strong. Alternatively, if the connectivity is poor, the algorithm can engage a subroutine to wait until connectivity is reestablished before automatically transmitting the completed adjustment. This step is necessary since many farmed fields are in remote locations.

Once the button to enter the adjusting data is pressed, the data flows to the AIP. Since the adjustment is essentially completed with receipt of the data by the AIP, algorithm within the AIP infrastructure can then automatically generate a check to pay for the claim. This is a major enhancement of efficiency for most AIPs since the industry standard at the time of this document's authorship (2015) is for each claim to pass through many hands on the way to payment. Instead, through the efficiency enabled by the digital nature of the present invention, adjustment of the claim is essentially completed when the adjuster presses enter. Human checking of claims may be desirable if certain conditions are triggered. For example, automatic flagging for inspection can be generated as a means to evaluate a statistical subsample of claims to ensure that the adjustment is appropriate and correct. Flagging could also be triggered in the event that the claim is excessively high-dollar or is non-standard in some other way.

### Flowcharts Describing the Workflow of the Present Invention

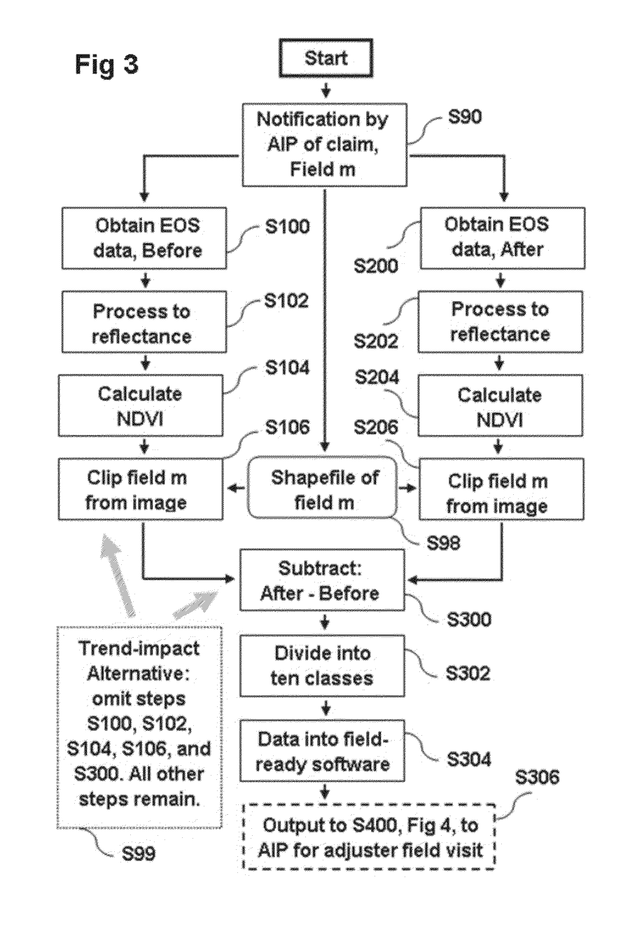

FIGS. 3, 4 and 5 present flow charts describing the workflow method of the present embodiment of the invention.

FIG. 3 contains the steps for calculation of data prior to the field visit for crop loss adjusting. The process begins at “Start”. At S90, the AIP provides notification of the claim which includes pertinent data that are transmitted to support the adjusting and calculation of the payout. This data includes the type of policy, farmer contact information and spatial data in the form of a shapefile of the field. Block S90 passes to block S98 that clips or extracts the data from the field whose boundaries are defined by the shapefile, from the image so that the analysis is specific to that field.

The decision to evaluate an event-caused or a trend-caused impact is called out in block S99 at the lower left hand corner. If the loss is event-caused, then all steps of FIG. 3 are followed. If trend-caused, then steps S100, S102, S104, S106, and S300 are omitted. For assessing trend-caused impacts, all other steps on FIG. 3 remain the same.

Returning to S100 that follows notification of an event-caused claim, an archived EOS image is obtained to represent the before condition. Next, this image is processed to reflectance at S102 following methods well known to a person of ordinary skill. At S104, the EOS image is converted to NDVI according to Equation 1 and at S106, the field is clipped out of the image to become the focus for the remainder of the steps in the workflow.

Returning to block S200, an EOS image is obtained to represent the after condition. The collection date of this image is ten or more days after the date of the event with this elapsed time allowing for the impacts from the event to mature and express. Passing to block S202 the after image is processed to reflectance and at S204 for calculation of NDVI. At S206, the field is clipped from the EOS image using a shapefile that defines Field m's borders to then become the focus for all further steps. The process then passes to S300 wherein pixelwise, the before condition is subtracted from the after condition if the impact was event-caused. Change Detection is omitted if the impact was a trend-caused.

At S302 the data, either NDVIᵢ of a trend-caused loss or ΔNDVIᵢ of an event-caused loss is divided into the ten classes as described in Equations 3 and 4. Passing to S304, the ten classes and other pertinent data for calculation of indemnities are placed into field-ready algorithm and at S306, this is uploaded for the adjuster.

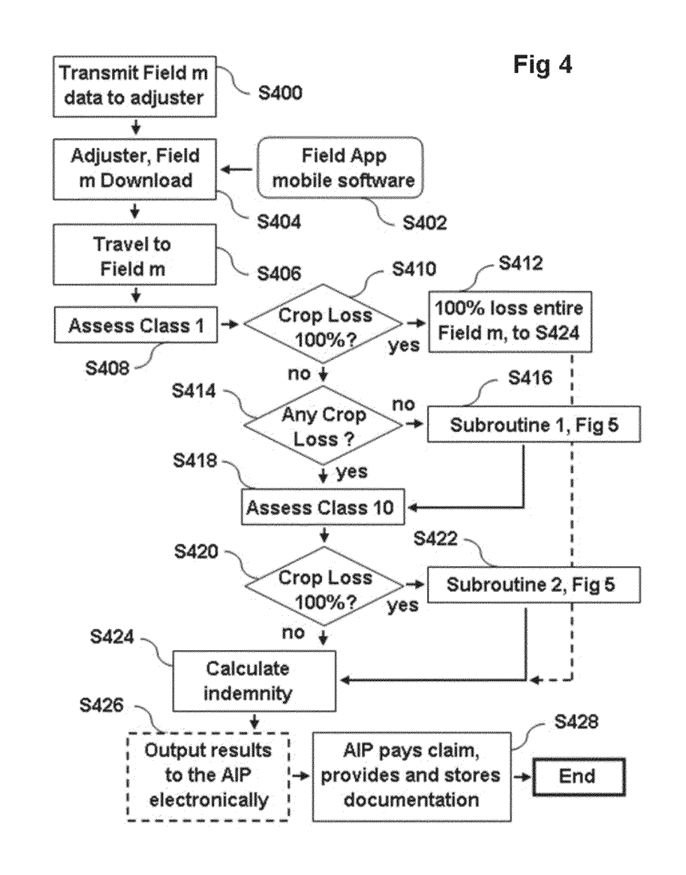

Block S400 of FIG. 4, is the start of the field loss-adjusting phase. FIG. 4 is the field operations for adjusting the crop loss on Field m, Field m being any field of focus for application of the present invention. At S400 the data from the calculations of FIG. 3 are transmitted to the adjuster who downloads the data at S404 for use by the Field App that was downloaded earlier to the smartphone at S402. The adjuster then travels to Field m at S406 and begins the adjusting operation by visiting and assessing Class 1, the portion of the field having the least impact (S408). If Class 1 has 100% crop loss, the answer to query S410 is yes and the workflow passes to S412 that concludes that Field m is a complete loss, passing to S424 to calculate the indemnity.

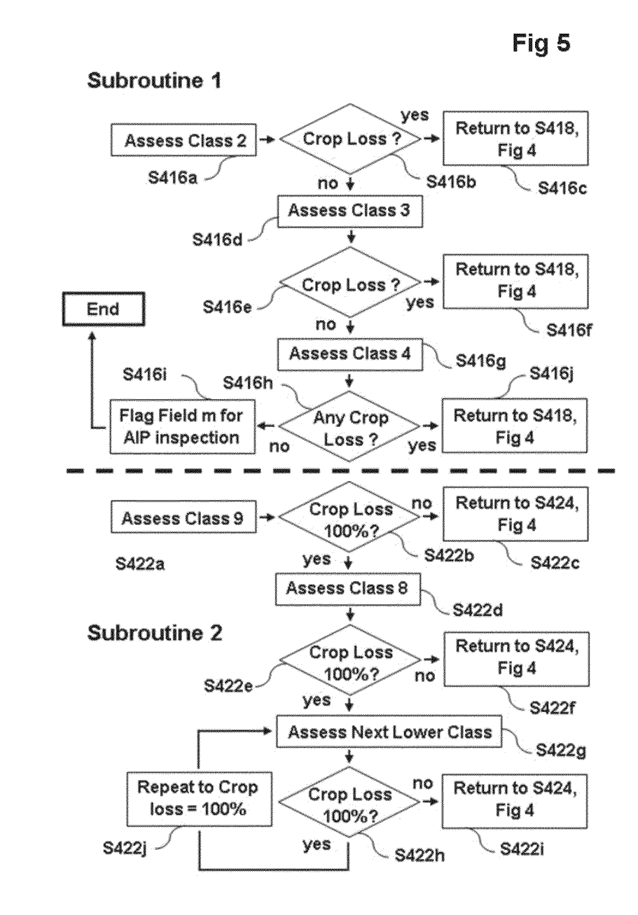

Returning to Query S410, if the answer is no, the crop loss is less than 100%, the workflow then passes to query S414 that asks if there is any crop loss. A no answer passes to Subroutine 1 on FIG. 5. Note that if there is crop loss at S414, then this percent crop loss will constitute the endmember to characterize the class with the least crop loss.

The purpose of Subroutines 1 and 2 is to insure that the algorithm correctly performs linear interpolation between the 100% loss and the least loss impact on the field that experienced any loss. The two subroutines ensure that if multiple classes on the field have either zero or 100% loss, that the endmembers are correctly chosen to enable unbiased linear interpolation to represent the losses on Field m. Superfluous 100% or 0% losses are stored in a buffer to enter into the calculations.

Subroutine 1 establishes the minimum damage class in the event that Class 1 had zero loss recorded. Subroutine 1 begins by assessing Class 2 at box S416a. Again at S416b, a query asks whether there is crop loss. In the event of a yes, the process passes back at S416c to S418 of FIG. 4 to begin assessing the worst impacts on the field for class 10. A yes answer to S416b establishes the lowest impact for the lowest class number.

Returning to S416b, a no answer directs the adjuster to the location for adjusting Class 3. A query is then posed whether there is crop loss on Class 3. If the answer is yes, the process passes to S416f that returns the process to S418 to begin assessing impacts on the worst location. This same process repeats through the assessment of Class 4 at S416h and if the answer to the query for whether crop loss is present is yes, the process passes to S418. If the answer is no, then the process passes to S416i that flags Field m for inspection since the algorithm has not yet recorded an impact—a nonsense result that indicates that Field m is likely not impacted for some reason, for example an incorrect shapefile was sent or there was a mistake in attributing impacts to Field m. If the answer is yes, then the process returns to S418.

Back to FIG. 4, S418 starts the assessment of the class with the greatest impacts in Field m, Class 10. The query S420 asks whether the crop loss was 100%. If the

The answer is no, it passes to S424 to calculate the indemnity. If the answer to S420 is yes, it passes to S422 directing the adjuster to subroutine 2 on FIG. 5. S422a assesses class 9 and at S422b the query is again asked whether the crop loss is 100%. An answer of no infers that the impact is less than 100% passing through S422c to S424 of FIG. 4 to complete the adjustment. A yes answer passes to assessing Class 8 at S422d passing to S422e with the query asking again whether the crop loss is 100%. A no answer passes to S422f and again to S424 of FIG. 4 to complete the adjustment. A yes answer passes to assess the next lower class in a do loop that begins at S422g with the no answer passing to S424, FIG. 4, and a yes answer to repeating the assessment with the next lower class through the query at S422h and the repeating operation at S422j. The process will finally feed back to S422i that passes to S424 of FIG. 4.

The process is directed to Subroutines 1 and 2 in the event of unusual circumstances and more commonly when there is 100% loss throughout much of the field. Subroutine 1 governs the workflow when the impacts to the field are very light—conditions in which farmers generally do not file for losses because some minimum loss must occur before a payout is made. Hence, Subroutine 1 will rarely see usage. A person of ordinary skill will recognize that the workflow represented by FIGS. 3 through 5 would be superfluous in the event that the entire field were impacted at 100% loss. The present invention will be completely automated up to the point of sending an adjuster to the field, the most expensive part of the loss adjusting operation. Hence, there is an economic incentive to avoid sending adjusters to fields that are complete losses.

Not shown on the flowcharts is the need for a counter to track the number of classes with 100% loss for calculation of the total indemnity in the event that the higher levels of impact are not true endmembers. A person of ordinary skill will recognize that this counter is a necessary addition to the simplified flowchart while the calculations with this additional consideration are relatively simple.

Adjusting fields that are so severely impacted that they are complete losses can be avoided by a simple prescreening step to assess the level of impacts using an NDVI* threshold. Such extreme impacts are rare however, adding a step to protect against mobilizing adjusters to many hundreds of fields is a simple addition that a person of ordinary skill will recognize can be crafted from the various methods used within the workflow. In the event of such extreme impacts the claim can simply be passed directly to payment of the full indemnity for complete loss.

Returning to S424 of FIG. 4, the indemnity for the crop loss is calculated according to mathematics specified for the Field m policy and Equation 5. The process then passes to S426 that outputs the results to the AIP electronically. Referring back to the smartphone mockup on FIG. 2, this event would occur through pressing the enter button in the example display. At S428 the maps and data developed during the field visit are used by the AIP for processing and paying the claim, documentation of the adjustment with maps and data sent to the farmer of Field m, and storing the data from the adjustment to defend the claim settlement in the event that the adjustment is challenged.

The embodiment method of the present invention can end with the adjuster pressing enter. However, the present invention enables further benefits to the AIP through efficient and rapid handling of the claims by streamlining the steps necessary to process and implement the claim, once adjusted. The file that is sent can contain an electronic record of the adjustment to serve as documentation for all parties. Once the AIP receives the electronic adjustment, depending upon their operating procedures, the algorithm can automatically generate a check and send documentation to the farmer and the farmer's crop insurance agent. The documentation will readily show that the claim was handled correctly and that the payout was appropriate. Such thorough documentation is expected to virtually end the occurrence of snagged claims.

A preferred embodiment of the invention has been described but it will be understood by those of ordinary skill in the art that modifications may be made without departing from the spirit and scope of the invention of the system and method. Accordingly, it is to be understood that the invention is not to be limited by the specific illustrated and described embodiments but only by the scope of the appended claims.

I claim:

1. A system and method for use of remote sensing analysis to provide digital maps and methods to assist crop loss adjusting for any loss-affected field m comprising:
classifying and ranking impacts across field m defined by a shapefile outline using EOS data;
guiding a crop loss adjuster to specific parts of field m for assessment of loss at selected locations based on execution of an algorithm in a portable device that includes GPS capability carried by the crop loss adjuster;
calculating the degree of crop loss on field m according to the applicable policy type and its indemnification limits for the policy underwritten by an AIP based on the assessment of loss of specific parts of field m;
transmitting directly or indirectly the results from said calculation to the underwriting AIP via internet and wireless connectivity; and
automatically handling the claim for field m crop loss, payout of the claim indemnification, and documenting the procedure and results of field m crop loss assessment based on the crop loss calculation.

2. The method of claim 1 for calculating the indemnification for the crop loss wherein the loss arose from an event wherein said calculation comprises:
collecting and storing data for field m including type of loss, date of event, type of policy, maximum indemnification per acre in the event of a 100% loss, and a shapefile of field m;
obtaining cloud-free Earth observation satellite imagery (EOS) that includes field m from within two weeks before the event that consists of a raster of pixels;
obtaining cloud-free EOS data that includes field m after the event that consists of a raster of pixels;
calculating reflectance for said EOS images;
calculating NDVI for said EOS images from the reflectance;
subtracting pixel values of said NDVI; after the crop loss event minus before the crop loss event, resulting in a change detection raster of pixels;
clipping out field m from the change detection raster to prepare the field m raster pixels for further calculations;
classifying the changes to field m raster pixels into multiple classes of change detection and ranking the classes from lowest to highest change;
defining locations within each ranked class for potential field visit by the crop loss adjuster assigning to the highest degree of negative change the highest class number from the multiple classes and to the lowest degree of negative change the lowest class number;
uploading an algorithm to a portable device that specifies the classes and locations to be assessed within field m with an additional algorithm supporting navigation directly to each location using the GPS functions contained by the portable device;
transmitting to the portable device maps of the classes of change detection values based on field m raster pixel values;
transmitting to the portable device navigation directions to selected locations of field m based on field m raster values;
visiting each selected location in field m and recording the crop loss,
if the highest class has less than 100% loss, accepting that class as the high-loss endmember for purposes of interpolation of the loss throughout all classes in field m and if the highest class has 100% crop loss, visiting the next lower class in field m to assess the percentage of crop loss;
if the next lower class has less than 100% loss, accepting the highest class as the high-loss endmember for purposes of interpolation of the loss throughout all classes in field m, and if said next lower class is 100% loss, visiting the next lower class in field m to assess the percentage of crop loss;
if the third highest class has less than 100% loss, accepting the next higher class as the high-loss endmember for purposes of interpolation of the loss throughout the remaining classes in field m,
continuing to visit each successively lower class to find the high-loss endmember for interpolating crop losses through field m as contained in the previous steps;
if the lowest class is greater than zero, accepting that class as the low-loss endmember for purposes of interpolation of the loss throughout all classes in field m and if the lowest class has no crop loss, visiting the second lowest class in field m to assess the percentage of crop loss;
if the second lowest class has crop loss exceeding 0%, accepting the lowest class as the low-loss endmember for purposes of interpolation of the loss throughout all classes in field m, and if said second lowest class is 0% loss, visiting the third lowest class in field m to assess the percentage of crop loss;
if the third lowest class has greater than 0% loss, accepting the second lowest class as the low-loss endmember for purposes of interpolation of the loss throughout the remaining classes in field m,
continuing to visit each successively higher class to find the low-loss endmember for interpolating crop losses through field m as contained in the previous steps;
interpolating the classes across field m between the low-loss and high-loss endmembers to assess crop losses throughout field m while retaining the 100% losses within any additional classes of field m above the high-loss endmember that was established for interpolation;
multiplying the losses within each class of field m, by the area of each class, and by the maximal indemnified value that is the 100% loss per area, and with consideration of the type of indemnification for field m,
and in the event that other policies are written for field m by the AIP, calculating the losses as in the previous steps for any additional policy(s) and in consideration for any stipulations in the calculation of the indemnity;
totaling the indemnification for each crop loss class for field m, and for the policy(s), and sending the total(s) and all background information used in the assessment and calculation by wireless connectivity to the AIP that indemnified field m; and
use by the AIP of the transmitted information to process and pay the claim for field m, provide documentation to the farmer of field m, and to defend the calculation of the indemnity of field m in the event that the indemnification is challenged.

3. The method of claim 1 for calculating the indemnification for the crop loss wherein the loss arose from a trend wherein said calculation comprises:
collecting and storing data for field m including type of loss, type of policy, maximum indemnification per acre in the event of a 100% loss, and a shapefile of field m;
obtaining cloud-free EOS data that includes field m from a period that is at from 70% to 100% passage of the normal crop growth cycle that consists of a raster of pixels;
calculating reflectance for said EOS image;
calculating NDVI for said EOS image from the reflectance;
clipping out field m from the change detection raster to prepare the field m raster pixels for further calculations;
classifying the raster pixel values into multiple classes of NDVI values and ranking the classes from lowest to highest value;
defining locations within each ranked class for potential field visit by the crop loss adjuster, assigning to the lowest values of NDVI to the lowest class number and the highest value NDVI to the highest class number;
uploading an algorithm to a portable device that specifies the NDVI classes and locations to be assessed within field m with an additional algorithm supporting navigation directly to each location using the GPS functions contained by the portable device;
transmitting to the portable device maps of the classes NDVI values based on field m raster pixel values;
transmitting to the portable device navigation directions to selected locations of field m based on field m raster values;
visiting each selected location in field m and recording the crop loss,
if the highest class has less than 100% loss, accepting that class as the high-loss endmember for purposes of interpolation of the loss throughout all classes in field m and if the highest class has 100% crop loss, visiting the next lower class in field m to assess the percentage of crop loss;
if the next lower class has less than 100% loss, accepting the highest class as the high-loss endmember for purposes of interpolation of the loss throughout all classes in field m, and if said next lower class is 100% loss, visiting the next lower class in field m to assess the percentage of crop loss;
if the third highest class has less than 100% loss, accepting the next higher class as the high-loss endmember for purposes of interpolation of the loss throughout the remaining classes in field m,
continuing to visit each successively lower class to find the high-loss endmember for interpolating crop losses through field m as contained in the previous steps;
if the lowest class is greater than zero, accepting that class as the low-loss endmember for purposes of interpolation of the loss throughout all classes in field m and if the lowest class has no crop loss, visiting the second lowest class in field m to assess the percentage of crop loss;
if the second lowest class has crop loss exceeding 0%, accepting the lowest class as the low-loss endmember for purposes of interpolation of the loss throughout all classes in field m, and if said second lowest class is 0% loss, visiting the third lowest class in field m to assess the percentage of crop loss;
if the third lowest class has greater than 0% loss, accepting the second lowest class as the low-loss endmember for purposes of interpolation of the loss throughout the remaining classes in field m,
continuing to visit each successively higher class to find the low-loss endmember for interpolating crop losses through field m as contained in the previous steps;
interpolating the classes across field m between the low-loss and high-loss endmembers to assess crop losses throughout field m while retaining the 100% losses within any additional classes of field m above the high-loss endmember that was established for interpolation;
multiplying the losses within each class of field m, by the area of each class, and by the maximal indemnified value that is the 100% loss per area, and with consideration of the type of indemnification for field m,
and in the event that other policies are written for field m by the AIP, calculating the losses as in the previous steps for any additional policy(s) and in consideration for any stipulations in the calculation of the indemnity;
totaling the indemnification for each crop loss class for field m, and for the policy(s), and sending the total(s) and all background information used in the assessment and calculation by wireless connectivity to the AIP that indemnified field m; and
use by the AIP of the transmitted information to process and pay the claim for field m, provide documentation to the farmer of field m, and to defend the calculation of the indemnity of field m in the event that the indemnification is challenged.
